(19) United States
(12) Patent Application Publication
(10) Pub. No.: US 2021/0399312 A1
(43) Pub. Date: Dec. 23, 2021

(54) HIGH STABILITY PLATINUM-BASED ELECTROCHEMICAL CATALYSTS

(71) Applicant: THE REGENTS OF THE UNIVERSITY OF CALIFORNIA, Oakland, CA (US)

(72) Inventors: Yu Huang, Los Angeles, CA (US); Xiangfeng Duan, Los Angeles, CA (US); Zipeng Zhao, Los Angeles, CA (US)

(73) Assignee: THE REGENTS OF THE UNIVERSITY OF CALIFORNIA, Oakland, CA (US)

(21) Appl. No.: 17/290,542

(22) PCT Filed: Oct. 30, 2019
(86) PCT No.: PCT/US2019/058944

§ 371 Date: Apr. 30, 2021

Related U.S. Application Data
(60) Provisional application No. 62/754,278, filed on Nov. 1, 2018.

(51) Int. Cl. H01M 4/92; H01M 4/88; H01M 12/06

(52) U.S. Cl. CPC H01M 4/921; H01M 4/8882; H01M 2004/8689; H01M 12/06; H01M 4/925

(57) ABSTRACT

An electrode material includes: (1) a catalyst support; and (2) PtNiN-M nanostructures affixed to the catalyst support, wherein N is a transition metal selected from Group 9 and Group 11 of the Periodic Table, and M is a transition metal selected from Group 5 and Group 6 of the Periodic Table.

### CROSS-REFERENCE TO RELATED APPLICATIONS

This application claims the benefit of U.S. Provisional Application No. 62/754,278, filed Nov. 1, 2018, the contents of which are incorporated herein by reference in their entirety.

### TECHNICAL FIELD

This disclosure generally relates to improved platinum (Pt)-based electrochemical catalysts.

### BACKGROUND

Proton-exchange membrane (PEM) fuel cells are desirable energy conversion devices for applications such as transportation vehicles and portable electronic devices, due to their high-energy density and low environmental impact in addition to being light-weight and affording low-temperature operation. PEM fuel cells operate based on reactions of a fuel (such as hydrogen or an alcohol) at an anode and an oxidant (molecular oxygen) at a cathode. Both cathode and anode reactions include catalysts to lower their electrochemical over-potential for high-voltage output, and so far, Pt has been the leading choice. To fully realize the commercial viability of fuel cells, the following challenges should be addressed: the high cost of Pt, the sluggish kinetics of the oxygen reduction reaction (ORR), and the low stability of Pt-based catalysts.

Alloying Pt with a secondary metal can reduce the usage of scarce Pt noble metal while at the same time provide improved performance as compared with that of pure Pt in terms of activity. Efforts have been applied towards platinum-nickel (PtNi) and platinum-cobalt (PtCo) as ORR catalysts for fuel cell cathode reactions. PtNi and PtCo catalysts have demonstrated activity ranging from several times to tens of times that of commercial Pt/C catalysts. However, stability remains an issue in PtNi and PtCo catalysts. In addition, single crystal study has revealed that bulk Pt₃Ni{111} facet can have an activity of about 18 mA/cm² at about 0.9 V vs. reversible hydrogen electrode (RHE), which is about 90 times compared to commercial Pt/C. However, the single crystal performance has not been matched by nanostructures, indicating room for further improvement. Thus, Pt-based nanostructures with both high catalytic activity and high stability, as well as further reduced usage of scarce Pt, have remained a challenge.

It is against this background that a need arose to develop the embodiments described herein.

### SUMMARY

In some embodiments, an electrode material includes: (1) a catalyst support; and (2) PtNiN-M nanostructures affixed to the catalyst support, wherein N is a transition metal selected from Group 9 and Group 11 of the Periodic Table, and M is a transition metal selected from Group 5 and Group 6 of the Periodic Table.

In additional embodiments, an electrode material includes: (1) a catalyst support; and (2) PtNi-based nanostructures affixed to the catalyst support, wherein at least one of the PtNi-based nanostructures includes an exterior shell of Pt.

In additional embodiments, an electrode material includes: (1) a catalyst support; and (2) PtNi-based nanostructures affixed to the catalyst support, wherein at least one of the PtNi-based nanostructures includes an exterior shell and a core surrounded by the exterior shell, and a molar content of Pt in the exterior shell is greater than a molar content of Pt in the core.

In additional embodiments, a fuel cell includes: (1) an anode; (2) a cathode; and (3) an electrolyte disposed between the anode and the cathode, wherein the cathode includes the electrode material of any of the foregoing embodiments.

In additional embodiments, a metal-air battery includes: (1) an anode; (2) a cathode; and (3) an electrolyte disposed between the anode and the cathode, wherein the cathode includes the electrode material of any of the foregoing embodiments.

In additional embodiments, a manufacturing method includes: (1) providing PtN nanostructures in a liquid medium, wherein N is a transition metal selected from Group 9 and Group 11 of the Periodic Table; and (2) reacting a M-containing precursor, a Pt-containing precursor, and a Ni-containing precursor in the liquid medium to form PtNiN-M nanostructures, wherein M is a transition metal selected from Group 5 and Group 6 of the Periodic Table.

In additional embodiments, a manufacturing method includes: (1) providing an electrode material including PtNi-based nanostructures affixed to a catalyst support; and (2) exposing the electrode material to an acid.

In further embodiments, a manufacturing method includes: (1) providing PtNiN nanostructures in a liquid medium, wherein N is a transition metal selected from Group 9 and Group 11 of the Periodic Table; and (2) reacting a Pt-containing precursor, a Ni-containing precursor, and a N-containing precursor with the PtNiN nanostructures in the liquid medium.

Other aspects and embodiments of this disclosure are also contemplated. The foregoing summary and the following detailed description are not meant to restrict this disclosure to any particular embodiment but are merely meant to describe some embodiments of this disclosure.

### BRIEF DESCRIPTION OF THE DRAWINGS

For a better understanding of the nature and objects of some embodiments of this disclosure, reference should be made to the following detailed description taken in conjunction with the accompanying drawings.

FIG. 1. Schematic of a fuel cell.

FIG. 2. Schematic of a metal-air battery.

FIG. 3. A) Transmission electron microscope (TEM) image of PtNiN or PtNiN-M octahedral catalyst after nitric acid wash. B) TEM image of PtNiN or PtNiN-M octahedral catalyst after nitric acid wash and annealing.

FIG. 4. Spectroscopic characterization and electrochemical performance of octahedral PtNi and PtNiCu nanoparticles. (a) Powder X-ray diffraction (XRD) spectra of octahedral PtNi/C, and PtNiCu/C (perpendicular lines represent standard XRD peak positions: Pt (PDF #04-0802), Ni (PDF #04-0850), and Cu (PDF #04-0836)). Atomic resolution STEM images of octahedral (b) PtNi, and (c) PtNiCu nanoparticles. Comparison of Pt/C, octahedral PtNi/C, and PtNiCu/C: (d) cyclic voltammetry (CV) curves measured in N₂ saturated about 0.1 M HClO₄ with scan rate of about 100 mV/s, (e) ORR polarization curves measured in O₂ saturated about 0.1 M HClO₄ with scan rate of about 20 mV/s, (f) specific activity (SA) and mass activity (MA), and (g) MA retention of PtNi/C and PtNiCu/C after ADT. Energy dispersive spectroscopy (EDS) composition analysis of atomic fraction of Ni and Cu at initial stage, after CV activation, and after ADT for (h) PtNi/C, and (i) PtNiCu/C. Octahedral PtNi/C, and PtNiCu/C are noted in figures as PtNi and PtNiCu.

FIG. 5. Time tracking study and simulation model construction. Time tracking of atomic ratio based on EDS and octahedral edge length based on TEM image for (a) PtNi, and (b) PtNiCu particles.

FIG. 6. Example TEM images of octahedral nanostructures on carbon support (a) PtNi/C, (b) PtNiCu/C.

FIG. 7. CO stripping test of (a) Pt/C, (b) octahedral PtNi/C, (c) octahedral PtNiCu/C (All above materials is recorded with a scan rate of about 25 mV/s in about 0.1M HClO₄). PtNi/C and PtNiCu/C are noted in all figures as PtNi and PtNiCu due to space constraint.

FIG. 8. ORR polarization curves of samples before and after ADT (15000, 30000 CV cycles) (a) Pt/C, (b) octahedral PtNi/C, (c) octahedral PtNiCu/C. (d) Mass activity comparison of Pt/C, PtNi/C, and PtNiCu/C after ADT (15000 and 30000 cycles).

FIG. 9. TEM images of samples before ADT (a) Pt/C, (b) octahedral PtNi/C, (c) octahedral PtNiCu/C. TEM images of samples after ADT (15000 cycles) (d) Pt/C, (e) octahedral PtNi/C, (f) octahedral PtNiCu/C. TEM images of samples after ADT (30000 cycles) (g) Pt/C, (h) octahedral PtNi/C, (i) octahedral PtNiCu/C.

FIG. 10. Time tracking of octahedral edge length based on TEM images of (a) PtNi/C, (b) PtNiCu/C.

FIG. 11. X-ray photoelectron spectroscopy (XPS) spectra of octahedral PtNi/C before activation for (a) Pt, (b) Ni. XPS spectra of octahedral PtNi/C after CV activation for (c) Pt, (d) Ni.

FIG. 12. XPS spectra of octahedral PtNiCu/C before activation for (a) Pt, (b) Ni, (c) Cu. XPS spectra of octahedral PtNiCu/C after CV activation for (d) Pt, (e) Ni, (f) Cu.

### DETAILED DESCRIPTION

Embodiments of this disclosure are directed to improved Pt-based electrochemical catalysts (or electrocatalysts) for ORR, exhibiting a combination of high activity and high stability, along with reduced usage of scarce Pt.

In some embodiments, a Pt-based electrocatalyst is an alloy of Pt and Ni. In some embodiments, the Pt-based electrocatalyst has a chemical composition that can be represented by the formula Pt₃Ni.

In some embodiments, a Pt-based electrocatalyst is an alloy of Pt, Ni, and at least one additional secondary metal having a chemical composition that can be represented by the formula PtₐNi_{b}N_{c} where any one or any combination of two or more of the following applies: (1) Pt represents platinum as a primary metal; (2) Ni represents nickel as a secondary metal; (3) N represents an additional secondary metal and with N being different from Pt and Ni, such as where N is at least one transition metal selected from Group 3, Group 4, Group 5, Group 6, Group 7, Group 8, Group 9, Group 10, Group 11, and Group 12 of the Periodic Table and with N being different from Pt and Ni; (4) “a” represents a molar content (e.g., expressed as a percentage) of Pt, “b” represents a molar content of Ni, “c” represents a molar content of N, with a>b, a>c, and also, in some embodiments, b≥c or c≥b or b being about the same as c; (5) “a” has a non-zero value in a range of about 51 to about 85, such as about 51 to about 80, about 55 to about 80, about 60 to about 80, about 60 to about 70, or about 65 to about 90; (6) “b” has a non-zero value in a range of about 5 to about 49, such as about 5 to about 40, about 5 to about 35, about 5 to about 30, about 5 to about 25, about 10 to about 20, or about 10 to about 25; (7) “c” has a non-zero value in a range of about 5 to about 49, such as about 5 to about 40, about 5 to about 35, about 5 to about 30, about 5 to about 25, about 10 to about 20, or about 10 to about 25; and (8) subject to the condition that a+b+c=100 (or 100%).

In some embodiments, a Pt-based electrocatalyst is an alloy of Pt, Ni, and at least two additional secondary metals having a chemical composition that can be represented by the formula PtₐNi_{b}N_{c}-M_{d} where any one or any combination of two or more of the following applies: (1) Pt represents platinum as a primary metal; (2) Ni represents nickel as a secondary metal; (3) N represents an additional secondary metal and with N being different from Pt and Ni, such as where N is at least one transition metal selected from Group 3, Group 4, Group 5, Group 6, Group 7, Group 8, Group 9, Group 10, Group 11, and Group 12 of the Periodic Table and with N being different from Pt and Ni; (4) M represents a further secondary metal and with M being different from Pt, Ni, and N, such as where M is at least one transition metal selected from Group 3, Group 4, Group 5, Group 6, Group 7, Group 8, Group 9, Group 10, Group 11, and Group 12 of the Periodic Table and with M being different from Pt, Ni, and N; (5) “a” represents a molar content (e.g., expressed as a percentage) of Pt, “b” represents a molar content of Ni, “c” represents a molar content of N, and “d” represents a molar content of M, with a>b, a>c, and a>d and also, in some embodiments, b>d and c>d; (6) “a” has a non-zero value in a range of about 51 to about 85, such as about 51 to about 80, about 55 to about 80, about 60 to about 80, about 60 to about 70, or about 65 to about 90; (7) “b” has a non-zero value in a range of about 5 to about 49, such as about 5 to about 40, about 5 to about 35, about 5 to about 30, about 5 to about 25, about 10 to about 20, or about 10 to about 25; (8) “c” has a non-zero value in a range of about 5 to about 49, such as about 5 to about 40, about 5 to about 35, about 5 to about 30, about 5 to about 25, about 10 to about 20, or about 10 to about 25; (9) “d” has a non-zero value in a range of 0 to about 8, such as about 0.1 to about 8, about 0.5 to about 5, about 0.5 to about 3, or about 0.5 to about 2.5; and (10) subject to the condition that a+b+c+d=100 (or 100%).

In some embodiments, N is at least one transition metal selected from Group 9 and Group 11 of the Periodic Table. In some embodiments, N is copper (Cu). In some embodiments, N is silver (Ag). In some embodiments, N is cobalt (Co). In some embodiments, by introducing N into a PtNi octahedral catalyst, a resulting PtNiN octahedral catalyst can reach both high activity and stability, along with reduced usage of scarce Pt noble metal. In some embodiments, the introduction of N results in an increase in a molar content of Pt atoms at or near exterior surfaces, which reduces an amount of surface vacancies and thus mitigates against the dissolution of atoms from sub-surface layers to retain activity and provide enhanced stability.

In some embodiments, M is at least one transition metal selected from Group 5 and Group 6 of the Periodic Table. In some embodiments, M is one or more of molybdenum (Mo), tungsten (W), niobium (Nb), and tantalum (Ta). In some embodiments, N is Co, and M is Mo. In some embodiments, N is Co, and M is W. In some embodiments, N is Co, and M is Nb. In some embodiments, N is Co, and M is Ta.

In other embodiments, N and M are different transition metals selected from Group 5, Group 6, Group 7, Group 8, Group 9, and Group 11 of the Periodic Table. In some embodiments, N and M are different transition metals selected from iron (Fe), chromium (Cr), manganese (Mn), Mo, Nb, W, Ta, Co, and Cu.

In some embodiments, M is included at a lower molar content relative to Pt, Ni, and N, and can be referred to as a dopant or a doping element. In some embodiments, M is included so as to be localized at or near exterior surfaces to yield a surface-doped electrocatalyst. In some embodiments, by introducing M into a PtNiN octahedral catalyst, a resulting PtNiN-M octahedral catalyst can reach both high activity and stability, along with further reduced usage of scarce Pt noble metal. Due to highly stable characteristics of a transition metal oxide (where the transition metal M can be Nb, Ta, W, or Mo) in a fuel cell working environment, the presence of the transition metal oxide can help stabilize a PtNiN-based catalyst.

In some embodiments, post-synthesis annealing of a Pt-based electrocatalyst forms an exterior shell of Pt, which can be beneficial in impeding leaching of a transition metal (e.g., Ni, N, or M) during operation that can lead to PEM poisoning. In some embodiments, a molar content of Pt within the exterior shell is greater than a molar content of Pt within a core surrounded by the exterior shell, such as at least about 1.05 times greater, at least about 1.1 times greater, at least about 1.15 times greater, or at least about 1.2 times greater. In some embodiments, at least about 70%, at least about 80%, at least about 90%, or at least about 95% of atoms located within a depth of 5 atomic layers from an exterior of a nanostructure, such as within 4 atomic layers, within 3 atomic layers, or within 2 atomic layers, are Pt atoms.

In some embodiments, a Pt-based electrocatalyst includes multiple nanostructures having the above-noted chemical composition, where any one or any combination of two or more of the following applies: (1) the nanostructures have sizes (or have an average size) in a range of up to about 100 nm, up to about 50 nm, up to about 40 nm, up to about 30 nm, up to about 20 nm, up to about 15 nm, up to about 10 nm, up to about 9 nm, up to about 8 nm, up to about 7 nm, up to about 6 nm, up to about 5 nm, or up to about 4.5 nm, and down to about 4 nm, down to about 3.5 nm, or less; (2) the nanostructures have at least one dimension or extent (or have at least one average dimension or extent) in a range of up to about 100 nm, up to about 50 nm, up to about 40 nm, up to about 30 nm, up to about 20 nm, up to about 15 nm, up to about 10 nm, up to about 9 nm, up to about 8 nm, up to about 7 nm, up to about 6 nm, up to about 5 nm, or up to about 4.5 nm, and down to about 4 nm, down to about 3.5 nm, or less; (3) the nanostructures have aspect ratios (or have an average aspect ratio) in a range of up to about 3, such as about 1 to about 3, about 1 to about 2.5, about 1 to about 2, or about 1 to about 1.5, or in a range of greater than about 3, such as about 4 or greater, about 5 or greater, or about 10 or greater; and (4) the nanostructures are largely or substantially crystalline, such as with a percentage of crystallinity (by volume or weight) of at least about 50%, at least about 60%, at least about 70%, at least about 80%, at least about 90%, at least about 95%, at least about 98%, or at least about 99% or more. Nanostructures of a Pt-based electrocatalyst can have a variety of morphologies, such as in the form of octahedra having exposed {111} facets, although other morphologies are encompassed by this disclosure, including nanoparticles, nanorods, nanowires, or other elongated nanostructures having aspect ratios greater than about 3, as well as core-shell nanostructures, core-multi-shell nanostructures, and nanoparticle-decorated cores, among others.

In some embodiments, a Pt-based electrocatalyst includes multiple nanostructures that are loaded on, dispersed in, affixed to, anchored to, or otherwise connected to a catalyst support, such as carbon black. In place of, or in combination with, carbon black, another catalyst support having suitable electrical conductivity can be used, such as another carbon-based support in the form of graphene, carbon fiber paper, or carbon cloth, as well as metallic foams, among others. A combination of a Pt-based electrocatalyst loaded on a catalyst support can be referred to as an electrode material. A Pt-based electrocatalyst can be loaded on multiple supports, including a primary support, such as a two-dimensional support, along with a secondary support, such as to provide desired spacing between or mitigate against stacking of the primary support. The electrocatalyst should be well dispersed on the two-dimensional, primary support, and conductivity of both primary and secondary supports should be adequate for improved performance.

In some embodiments, a Pt-based electrocatalyst can be formed according to a manufacturing method including: (1) providing a dispersion of PtN nanostructures affixed to a catalyst support in a liquid medium; and (2) reacting a M-containing precursor, a Pt-containing precursor, and a Ni-containing precursor in the liquid medium to form PtNiN-M nano structures.

In some embodiments, providing the dispersion in (1) includes reacting a Pt-containing precursor (which can be the same as or different from the Pt-containing precursor used in (2)) and a N-containing precursor in the presence of the catalyst support in the liquid medium to form the dispersion of PtN nanostructures affixed to the catalyst support. Suitable Pt-containing precursors (used in (1) and (2)) include an organometallic coordination complex of Pt with an organic anion, such as acetylacetonate, suitable N-containing precursors (used in (1)) include an organometallic coordination complex of N with an organic anion, such as acetate, suitable M-containing precursors (used in (2)) include an organometallic coordination complex of M with an organic anion, such as acetylacetonate, ethoxide, or phenoxide, and suitable Ni-containing precursors (used in (2)) include an organometallic coordination complex of Ni with an organic anion, such as acetate. The liquid medium includes one or more solvents, such as one or more organic solvents selected from polar aprotic solvents, polar protic solvents, and non-polar solvents. A solvent that is used should have requisite purity. In some embodiments, a solvent included in the liquid medium also can serve as a reducing agent for reduction of Pt, Ni, N, and M, although the inclusion of a separate reducing agent is also contemplated. In some embodiments, a structure-directing agent, such as benzoic acid or other aromatic carboxylic acid, is also included in the liquid medium to promote a desired morphology of Pt-based nano structures. Reaction can be carried out under agitation and under conditions of a temperature in a range of about 100° C. to about 300° C. or about 100° C. to about 250° C., and a time duration in a range of about 2 hours to about 24 hours or about 6 hours to about 18 hours.

In some embodiments, the omission of a Ni-containing precursor when reacting the Pt-containing precursor and the N-containing precursor in (1) can enhance a reduction rate of N. In particular, the presence of the Ni-containing precursor can suppress the reduction of the N-containing precursor, since Ni can be more readily reduced compared to certain transition metals. By omitting a Ni-containing precursor in (1), a higher molar content of N can be incorporated into a resulting electrocatalyst.

In some embodiments, reacting in (2) includes adding or otherwise incorporating the M-containing precursor, the Pt-containing precursor (which can be the same as or different from the Pt-containing precursor used in (1)), and the Ni-containing precursor to the liquid medium. Reaction can be carried out under agitation and under conditions of a temperature in a range of about 100° C. to about 300° C. or about 100° C. to about 250° C., and a time duration in a range of about 12 hours to about 60 hours or about 24 hours to about 60 hours. The resulting (freshly prepared) electrocatalyst can be kept in a sealed container for long-term preservation.

In some embodiments, a Pt-based electrocatalyst can be formed according to a manufacturing method including: (1) providing a dispersion of PtNiN nanostructures affixed to a catalyst support in a liquid medium; and (2) reacting a Pt-containing precursor, a Ni-containing precursor, a N-containing precursor, and a M-containing precursor in the liquid medium to form PtNiN-M nano structures.

In some embodiments, providing the dispersion in (1) includes reacting a Pt-containing precursor (which can be the same as or different from the Pt-containing precursor used in (2)), a Ni-containing precursor (which can be the same as or different from the Ni-containing precursor used in (2)), and a N-containing precursor (which can be the same as or different from the N-containing precursor used in (2)) in the presence of the catalyst support in the liquid medium to form the dispersion of PtNiN nanostructures affixed to the catalyst support. Suitable Pt-containing precursors (used in (1) and (2)) include an organometallic coordination complex of Pt with an organic anion, such as acetylacetonate, suitable N-containing precursors (used in (1) and (2)) include an organometallic coordination complex of N with an organic anion, such as acetate, suitable M-containing precursors (used in (2)) include an organometallic coordination complex of M with an organic anion, such as acetylacetonate, ethoxide, or phenoxide, and suitable Ni-containing precursors (used in (1) and (2)) include an organometallic coordination complex of Ni with an organic anion, such as acetate. The liquid medium includes one or more solvents, such as one or more organic solvents selected from polar aprotic solvents, polar protic solvents, and non-polar solvents. In some embodiments, a solvent included in the liquid medium also can serve as a reducing agent for reduction of Pt, Ni, N, and M, although the inclusion of a separate reducing agent is also contemplated. In some embodiments, a structure-directing agent, such as benzoic acid or other aromatic carboxylic acid, is also included in the liquid medium to promote a desired morphology of Pt-based nanostructures. Reaction can be carried out under agitation and under conditions of a temperature in a range of about 100° C. to about 300° C. or about 100° C. to about 250° C., and a time duration in a range of about 2 hours to about 24 hours or about 6 hours to about 18 hours.

In some embodiments, reacting in (2) includes adding or otherwise incorporating the Pt-containing precursor (which can be the same as or different from the Pt-containing precursor used in (1)), the Ni-containing precursor (which can be the same as or different from the Ni-containing precursor used in (1)), the N-containing precursor (which can be the same as or different from the N-containing precursor used in (1)), and the M-containing precursor to the liquid medium. Reaction can be carried out under agitation and under conditions of a temperature in a range of about 100° C. to about 300° C. or about 100° C. to about 250° C., and a time duration in a range of about 12 hours to about 60 hours or about 24 hours to about 60 hours. The resulting (freshly prepared) electrocatalyst can be kept in a sealed container for long-term preservation.

According to some embodiments, a large scale synthesis (e.g., about 1 g per batch or more) of octahedral PtNiN and PtNiN-M electrocatalysts can be attained, which can provide a large amount of high performance electrocatalysts for fuel cells and other applications.

In some embodiments, a Pt-based electrocatalyst can be formed according to a manufacturing method including: (1) providing a dispersion of PtNiN nanostructures affixed to a catalyst support in a liquid medium; and (2) reacting a Pt-containing precursor, a Ni-containing precursor, and a N-containing precursor with the PtNiN nanostructures in the liquid medium to form the Pt-based electrocatalyst.

In some embodiments, providing the dispersion in (1) includes reacting a Pt-containing precursor (which can be the same as or different from the Pt-containing precursor used in (2)), a Ni-containing precursor (which can be the same as or different from the Ni-containing precursor used in (2)), and a N-containing precursor (which can be the same as or different from the N-containing precursor used in (2)) in the presence of the catalyst support in the liquid medium to form the dispersion of PtNiN nanostructures affixed to the catalyst support. Suitable Pt-containing precursors (used in (1) and (2)) include an organometallic coordination complex of Pt with an organic anion, such as acetylacetonate, suitable N-containing precursors (used in (1) and (2)) include an organometallic coordination complex of N with an organic anion, such as acetate, and suitable Ni-containing precursors (used in (1) and (2)) include an organometallic coordination complex of Ni with an organic anion, such as acetate. The liquid medium includes one or more solvents, such as one or more organic solvents selected from polar aprotic solvents, polar protic solvents, and non-polar solvents. In some embodiments, a solvent included in the liquid medium also can serve as a reducing agent for reduction of Pt, Ni, and N, although the inclusion of a separate reducing agent is also contemplated. In some embodiments, a structure-directing agent, such as benzoic acid or other aromatic carboxylic acid, is also included in the liquid medium to promote a desired morphology of Pt-based nanostructures. Reaction can be carried out under agitation and under conditions of a temperature in a range of about 100° C. to about 300° C. or about 100° C. to about 250° C., and a time duration in a range of about 2 hours to about 24 hours or about 6 hours to about 18 hours.

In some embodiments, reacting in (2) includes adding or otherwise incorporating the Pt-containing precursor (which can be the same as or different from the Pt-containing precursor used in (1)), the Ni-containing precursor (which can be the same as or different from the Ni-containing precursor used in (1)), and the N-containing precursor (which can be the same as or different from the N-containing precursor used in (1)) to the liquid medium. Reaction can be carried out under agitation and under conditions of a temperature in a range of about 100° C. to about 300° C. or about 100° C. to about 250° C., and a time duration in a range of about 12 hours to about 60 hours or about 24 hours to about 60 hours. The resulting (freshly prepared) electrocatalyst can be kept in a sealed container for long-term preservation.

By introducing a post-synthesis treatment, a PtNi-based octahedral electrocatalyst, such as PtNi, PtNiN or PtNiN-M octahedral electrocatalyst, can reach outstanding activity and stability in membrane electrode assembly (MEA)-based fuel cells, and can show significant improvement (e.g., about two times or more) compared to same catalysts without post-synthesis treatment.

In some embodiments, a post-synthesis treatment includes exposure of a Pt-based electrocatalyst to an acid, such as by adding or otherwise incorporating the Pt-based electrocatalyst in a liquid medium including the acid. Suitable acids include nitric acid, perchloric acid, sulfuric acid, another strong acid (e.g., pKₐ<−1.6), and combinations thereof. A concentration of the acid in the liquid medium can be in a range of about 0.1 molar (M) to about 2 M or about 0.1 M to about 1 M. Exposure to the acid can be carried out under conditions of a temperature in a range of about 30° C. to about 150° C. or about 40° C. to about 100° C., and a time duration in a range of about 1 hour to about 15 hours or about 2 hours to about 10 hours. Exposure to the acid can remove a metal oxide and a metal salt on a surface of the electrocatalyst, which otherwise can be dissolved by protons in a fuel cell operating environment. The dissolved metal oxide or metal salt can introduce cations within a catalyst layer, which can poison a membrane. For example, nitric acid can remove a metal oxide and a metal salt adsorbed on a carbon surface of a catalyst support during synthesis and mitigate against potential contamination.

Alternatively to or in combination with acid treatment, a post-synthesis treatment of some embodiments includes annealing a Pt-based electrocatalyst in a reducing environment, such as by exposure to an atmosphere of hydrogen gas (H₂) in an inert gas, such as argon (Ar). Annealing can be carried out under conditions of a temperature in a range of about 100° C. to about 300° C. or about 150° C. to about 250° C., and a time duration in a range of about 10 minutes to about 5 hours or about 10 minutes to about 2 hours. Annealing can form an exterior shell or “skin” of Pt in a Pt-based octahedral catalyst, which can be beneficial in impeding leaching of a transition metal during operation that can lead to membrane poisoning.

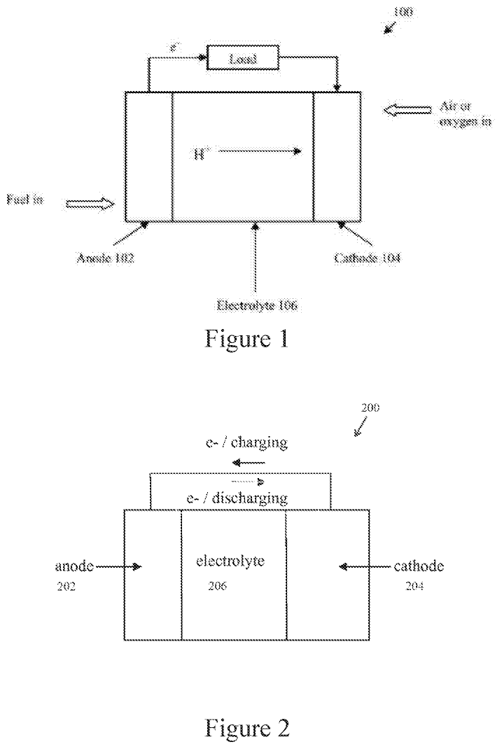

FIG. 1 is a schematic of a fuel cell 100 according to an embodiment of this disclosure. The fuel cell 100 includes an anode 102, a cathode 104, and an electrolyte 106 that is disposed between the anode 102 and the cathode 104. In the illustrated embodiment, the fuel cell 100 is a PEM fuel cell, in which the electrolyte 106 is implemented as a proton-exchange membrane, such as one formed of polytetrafluoroethylene or other suitable fluorinated polymer. During operation of the fuel cell 100, a fuel (such as hydrogen or an alcohol) is oxidized at the anode 102, and oxygen is reduced at the cathode 104. Protons are transported from the anode 102 to the cathode 104 through the electrolyte 106, and electrons are transported over an external circuit load. At the cathode 104, oxygen reacts with the protons and the electrons, forming water and producing heat. Either one, or both, of the anode 102 and the cathode 104 can include an electrocatalyst as set forth in this disclosure.

FIG. 2 is a schematic of a metal-air battery 200 according to an embodiment of this disclosure. The battery 200 can operate based on oxidation of lithium at an anode 202 and reduction of oxygen at a cathode 204 to induce a current flow. In the case of a Li-air battery, the anode 202 includes lithium metal, although other metals (e.g., zinc) can be included in place of, or in combination with, lithium metal. An electrolyte 206 is disposed between the anode 202 and the cathode 204, and can be an aprotic electrolyte, although other types of electrolytes are contemplated, such as aqueous, solid state, and mixed aqueous/aprotic electrolytes. The cathode 204 can include an electrocatalyst as set forth in this disclosure.

### EXAMPLES

The following examples describe specific aspects of some embodiments of this disclosure to illustrate and provide a description for those of ordinary skill in the art. The examples should not be construed as limiting this disclosure, as the examples merely provide specific methodology useful in understanding and practicing some embodiments of this disclosure.

### Example 1

Methods and Results

1. Typical Synthesis of PtNiN-M Catalysts on Carbon Support.

A) Synthesis of PtNiCo—Mo Catalyst on Carbon Support.

About 100-130 mg of carbon black was dispersed in about 120-180 mL of N,N-dimethylformamide (DMF) under ultrasonication for about 60 mins in an about 325 mL pressure vessel. Then about 110-150 mg of platinum(II) acetylacetonate [Pt(acac)₂], about 110-150 mg of cobalt(II) acetate tetrahydrate [Co(ac)₂.4H₂O], and about 1100-1500 mg of benzoic acid were dissolved in about 20 ml of DMF and were also added into the 300-400 ml pressure vessel with the carbon black dispersion. After ultrasonication for about 5 mins, the pressure vessel with well mixed solution was directly placed into an about 130-150° C. oil bath, and then heated to about 160° C. within about 0.5 hrs. The pressure vessel was then kept at about 160-170° C. for about 4-8 hrs.

After about 4-8 hrs, about 50-80 mg of Pt(acac)₂, about 150-190 mg of Ni(ac)₂.4H₂O, and about 25-35 mg of Bis(acetylacetonato)dioxomolybdenum(VI) [MoO₂(acac)₂] were dissolved in about 10 mL of DMF, and were added into the pressure vessel. Then the pressure vessel was kept in an about 160-170° C. oil bath for about 40-60 hrs. After the reaction finished, a resulting catalyst was collected by centrifugation, and then re-dispersed and washed with an isopropanol and acetone mixture. Then the catalyst was dried in air at room temperature. After the catalyst is substantially completely dried, about 100-150 mg of the dried catalyst was dispersed in about 15 mL of about 0.05-0.5 M HNO₃ or H₂SO₄ in an about 25 ml vial. The vial was keep at about 50-70° C. for about 4-8 hrs. After acid wash, the catalyst was washed by deionized water for 4 times, and then dried in vacuum. After substantially complete drying, the obtained catalyst is annealed at about 150-250° C. under Ar/H₂ mixture gas atmosphere. Then the obtained catalyst is ready for characterization and electrochemistry test.

B) Synthesis of PtNiCo—Nb, PtNiCo—Ta, and PtNiCo—W Catalysts.

In order to synthesize PtNiCo—Nb, PtNiCo—Ta, and PtNiCo—W nanocatalysts, a Mo-containing precursor is replaced with corresponding metal-containing precursors. About 25-35 mg Bis(acetylacetonato)dioxomolybdenum(VI) [MoO₂(acac)₂] (0.076-0.107 mmol) can be replaced with about 0.076-0.107 mmol of tantalum(V) ethoxide, tungsten(VI) ethoxide, or niobium(V) phenoxide precursor.

C) Synthesis of PtNiN-M Catalyst, in which N Represents Cu or Ag

For the synthesis of PtNiCu-M and PtNiAg-M, Co(ac)₂.4H₂O precursor can be replaced with about 0.44-0.6 mmol of copper(II) acetate or silver(I) acetate.

2. Characterization of PtNiCo-M on Carbon Support.

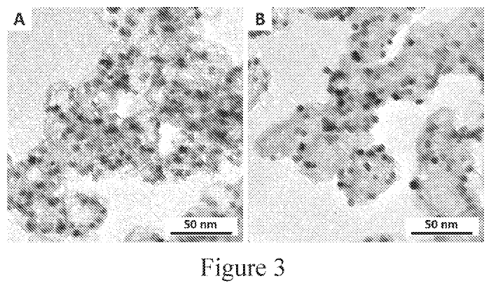

Transmission electron microscope (TEM) analysis of synthesized catalyst showed representative alloy nanostructures are well distributed on carbon support (FIG. 3). Scanning electron microscope (SEM) analysis showed a zoomed out distribution of representative nanostructures on carbon support. Energy dispersive spectroscopy (EDS) and inductively coupled plasma atomic emission spectroscopy (ICP-AES) showed the atomic composition of the PtNiN-M nanocatalyst is: Pt=about 70-80.0%, Ni=about 10-15%, N=about 10-15%, and M=about 1-3%.

### Example 2

Methods and Results

1. Large Scale Synthesis of Octahedral PtNiN and PtNiN-M Catalysts.

A) One Pot Synthesis of PtNiN-M Catalyst (N, M=Fe, Co, Cu, Cr, Mn, Mo, Nb, W, Ta, and so Forth).

About 400-700 mg of carbon black was dispersed in about 750-900 mL of N,N-dimethylformamide (DMF) in an about 1.8-2.5 L volume reaction vessel. About 600-800 mg of Pt-containing precursor (platinum(II) acetylacetonate), about 450-600 mg of nickel-containing precursor (nickel(II) acetate tetrahydrate), and other transition metal N-containing precursor (with a mole ratio of about 1:1 to about 0.5:1 (N:Ni=about 1:1 to about 0.5:1) compared to Ni-containing precursor) were added. In addition, about 6-8 g of benzoic acid was also dissolved in the solution. Then the solution was heated to about 150-160° C. for about 10-15 hrs. Then, about 150-200 mg of Pt-containing precursor (platinum(II) acetylacetonate), about 150-200 mg of nickel-containing precursor (nickel(II) acetate tetrahydrate), transition metal N-containing precursor with a mole ratio N:Ni of about 1:1 to about 0.5:1, together with another transition metal M-containing dopant precursor (M can be Mo, W, Nb, Ta, and so forth) with a mole ratio M:Ni of about 0.4:1 to about 1:1, were added into the solution. The solution was then kept at about 160-170° C. for about 40-60 hrs. After synthesis, a resulting catalyst was collected by centrifuge and washed 2 times with an isopropanol and acetone mixture. With the above method, more than about 1 g of the catalyst can be obtained with Pt overall weight loading of about 30-40%. By tuning the amount of carbon, the overall Pt weight loading can be tuned from about 5% to about 50%.

B) One Pot Synthesis of PtNiCo or PtNiCo-M Catalysts (M=Mo, Nb, W, Ta).

About 400-700 mg of carbon black was dispersed in about 750-900 mL of N,N-dimethylformamide (DMF) in an about 1.8-2.5 L volume reaction vessel. About 600-800 mg of Pt-containing precursor (platinum(II) acetylacetonate) and about 450-700 mg of cobalt-containing precursor (cobalt(II) acetate tetrahydrate) were added. In addition, about 6-8 g of benzoic acid was dissolved in the solution. Then the solution was heated to about 150-160° C. for about 4-8 hrs. Then, about 300-500 mg of Pt-containing precursor (platinum(II) acetylacetonate), about 800-900 mg of nickel-containing precursor (nickel(II) acetate tetrahydrate), and other transition metal M (or dopant)-containing precursor (M can be Mo, W, Nb, Ta) with a mole ratio M:Ni of about 0.4:1 to about 1:1 were added into the solution. The solution then was kept at about 160-170° C. for about 40-60 hrs. After synthesis, a resulting catalyst was collected by centrifuge and washed 2 times with an isopropanol and acetone mixture. With the above method, more than about 1 g catalyst can be obtained with Pt overall weight loading of about 30-40%. By tuning the amount of carbon, the overall Pt weight loading can be tuned from about 5% to about 50%.

C) Post Synthesis Treatment of Octahedral PtNiN and PtNiN-M Catalyst.

i. Acid Wash

i.1 Nitric Acid

Dried catalyst (octahedral PtNiN-M/C or octahedral PtNiN/C, N, M=Fe, Co, Cu, Cr, Mn, Mo, Nb, W, Ta, and so forth) was dispersed in about 0.1-0.5 M of HNO₃. The dispersion is kept at about 50-70° C. for about 4-8 hrs. Then the catalyst is collected by centrifuge and washed by pure water for 3 times.

i.2 Perchloric Acid

Dried catalyst (octahedral PtNiN-M/C or octahedral PtNiN/C, N, M=Fe, Co, Cu, Cr, Mn, Mo, Nb, W, Ta, and so forth) was dispersed in about 0.1-0.5 M of HClO₄. The dispersion is kept at about 40-70° C. for about 4-8 hrs. Then the catalyst is collected by centrifuge and washed by pure water for 3 times.

i.3 Sulfuric Acid

Dried catalyst (octahedral PtNiN-M/C or octahedral PtNiN/C, N, M=Fe, Co, Cu, Cr, Mn, Mo, Nb, W, Ta, and so forth) was dispersed in about 0.05-0.25 M of H₂SO₄. The dispersion is kept at about 50-70° C. for about 4-8 hrs. Then the catalyst is collected by centrifuge and washed by pure water for 3 times.

ii. Annealing

After acid wash, the dried catalyst can be annealed in about 1-5% H₂ in argon at about 150-250° C. for about 1-2 hr.

2. Result.

With a transition electron microscope (TEM), it can be observed that a majority of octahedral and octahedral-like morphology is maintained after acid wash and annealing. (FIG. 3).

### Example 3

### The Effect of Cu on Differential Surface Elemental Distribution and Stability of PtNi Catalysts

Overview

Platinum-nickel (PtNi) octahedral based nanomaterials represent a class of highly active catalysts for oxygen reduction reaction (ORR) in fuel cell applications. However, they suffer from poor stability operating in an acidic environment, which is a crucial challenge in maintaining their activity advantage over Pt in practical applications. In this example, it is shown that incorporation of copper (Cu) into octahedral PtNi nanoparticles has a profound effect in elemental distribution and performance of the nanocatalysts. The octahedral PtNiCu nanocatalysts showed significantly enhanced activity and stability compared to octahedral PtNi catalysts for ORR. Experiments and computational simulations demonstrate that the octahedral PtNiCu have improved Ni and Cu retention compared to PtNi after electrochemical cycles in acidic solution. Kinetic Monte Carlo simulations reveal that the enhanced stability can be attributed to the reduction in the number of (Ni and Cu) atoms on the surface of as-synthesized catalysts, which reduces the generation of surface vacancies, leading to suppressed diffusion of the metal atoms in sub-surface layers to the surface and mitigates against dissolution.

### INTRODUCTION

Fuel cells generate power by fuel oxidation at an anode and oxygen reduction at a cathode. Powered by renewable fuel with high energy conversion efficiency, fuel cells hold the potential for replacing internal combustion engines for powering automotive vehicles. Currently, the broad adoption of fuel cells is mainly constrained by their prohibitive cost. Reactions at both the anode and cathode, especially the oxygen reduction reaction (ORR) at the cathode, specify catalysts to lower their electrochemical overpotential and increase power output. In proton-exchange membrane (PEM) fuel cells, platinum (Pt)-based catalysts are used. To reach the widespread adoption of PEM fuel cells, several challenges should be addressed, including increasing the activity and durability of the catalysts and reducing the amount of Pt used. With highly active and durable catalysts, the operational cost of fuel cells can be substantially reduced.

Alloying Pt with transition metals is an approach to address the performance challenge of Pt-based electrochemical catalysts. A variety of structures and compositions of Pt-based alloy catalysts can be considered. To date, the best ORR specific activity (SA, activity normalized by electrochemical surface area (ECSA)) is achieved on Pt₃Ni(111) single crystal surface, which shows about 18 mA/cm² and is about 90 times more active than commercial Pt/C. Stimulated by this finding, efforts are made on developing nanocatalysts that approach the specific activity established on the Pt₃Ni(111) single crystal surface, as nanoscale catalysts hold the advantage of high mass activity (activity normalized by Pt mass loading) due to their high ECSA. With exposed (111) facets, Pt—Ni octahedral nanoparticles can reach drastically improved activity compared to commercial Pt/C catalysts, although challenges remained with regard to the poor stability. To further improve the activity as well as the stability of octahedral Pt—Ni nanomaterials, introducing a third element to form a ternary alloy or surface doping modification can be considered.

Herein, this example reports the synthesis of octahedral PtNiCu nanoparticles with well-controlled octahedral morphology and stable dispersity on carbon support in solution (details about synthesis are included in Supplementary Information). Of note, the octahedral PtNiCu nanoparticles are prepared via solution phase synthesis route. These PtNiCu nanocatalysts demonstrated improved activity and stability compared to PtNi of similar size and similar Pt-composition, as ORR catalysts. The growth of the PtNi and PtNiCu nanoparticles was recorded by time tracking experiments, and their respective size and composition at several time points were carefully analyzed. It was evident from the experiments that adding Cu changes the growth behavior of these nano-sized octahedral particles. In addition, a strong correlation between the initial differential Pt/Ni/Cu element distribution and the resultant varied stability was observed by comparing PtNi and PtNiCu in ORR performance.

### Results and Discussion

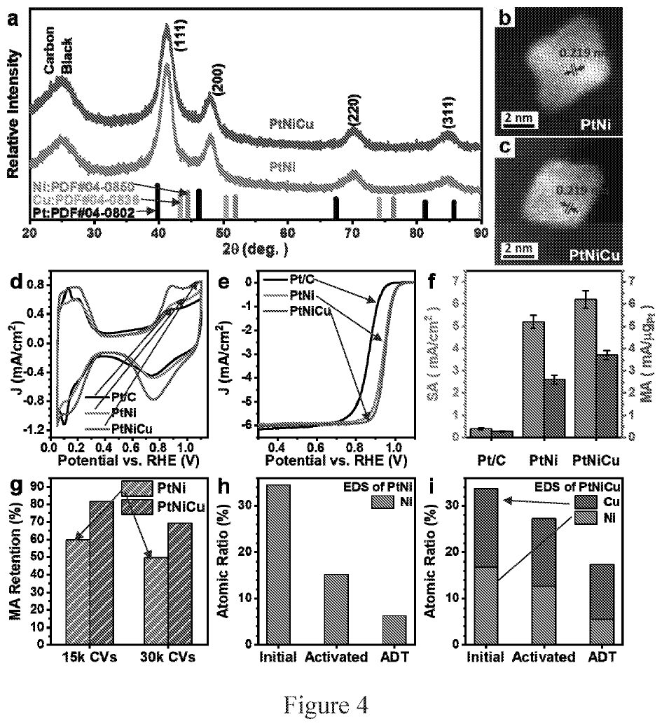

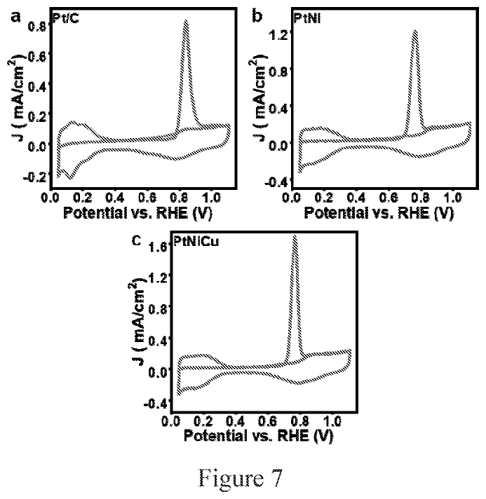

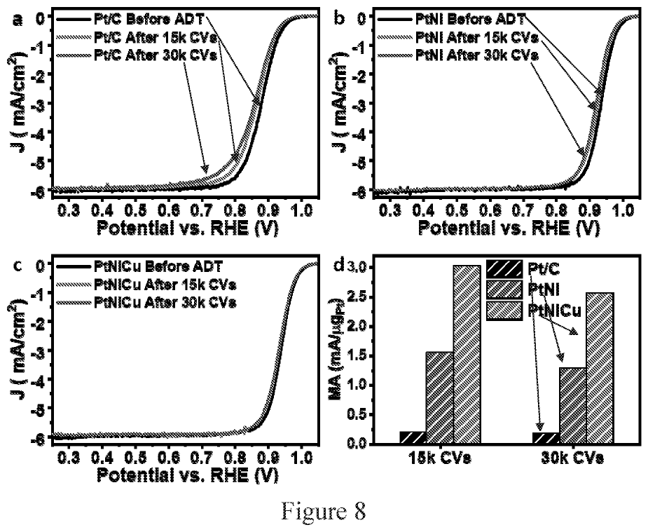

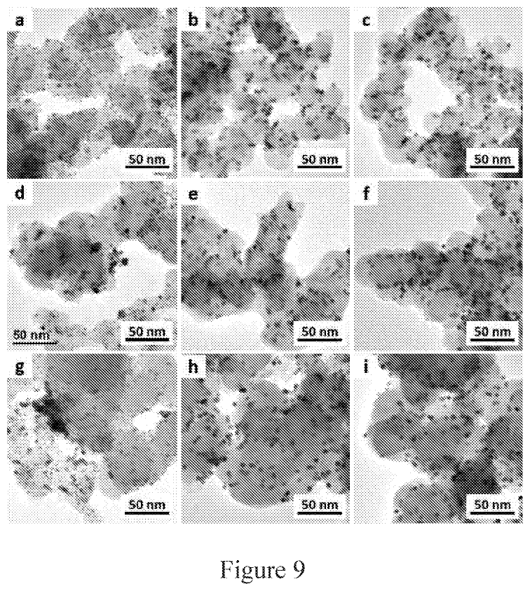

The synthesized PtNi and PtNiCu nanoparticles showed well-controlled octahedral morphology and uniform distribution on carbon black support, as shown in transmission electron microscope (TEM) images (FIG. 6). The edge lengths of the resultant octahedral PtNi and PtNiCu are comparable (5.0±0.6 nm for PtNi and 4.9±0.6 nm for PtNiCu as shown in FIG. 6). Powder X-ray diffraction (XRD) spectra show the atomic packing for these PtNi and PtNiCu alloys is face centered cubic (fcc) packing with a lattice parameter of about 0.379 nm (FIG. 4a), indicating substantially the same Pt ratio in these two alloys. Atomic resolution scanning transmission electron microscope (STEM) images revealed the (111) interplanar distances of the alloy PtNi and PtNiCu nanoparticles were about 0.219 nm (FIG. 4b, c). The lattice parameters based on STEM match well with those based on XRD spectra. These observations confirm that PtNi and PtNiCu were prepared with comparable morphology, size, Pt ratio, and lattice, leaving the difference between octahedral PtNi and PtNiCu to the Cu and Ni content. The electrochemical performance of the octahedral PtNiCu was studied in comparison of PtNi. CV curves were recorded for commercial Pt/C, octahedral PtNi and PtNiCu (FIG. 4d), in N₂ saturated about 0.1 M HClO₄ after CV activation (30 CV cycles for PtNi/C and PtNiCu/C, and 60 CV cycles for Pt/C). Electrochemical surface area (ECSA) was determined by integrating of hydrogen underpotential deposition (H_{upd}) charge (H_{upd} charge to surface area conversion constant: about 210 μC/cm²). CO stripping was also employed to evaluate the ECSA (FIG. 7, Table 1). ORR polarization curves were recorded in O₂ saturated about 0.1 M HClO₄ (FIG. 4e). The comparison of the above tests showed the mass activity (MA) and specific activity (SA) of octahedral PtNiCu/C were higher than those of octahedral PtNi (FIG. 4f). The octahedral PtNiCu showed about 15.9 times SA and about 13.2 times MA compared to commercial Pt/C. Several results from other studies are also included in Table 2 for comparison, confirming the high performance of the prepared PtNiCu/C. To study the stability of catalysts, the above octahedral nanoparticles were tested in O₂ saturated about 0.1 M HClO₄ for 30000 CV cycles for an accelerated durability test (ADT). Octahedral PtNiCu showed about 69.3% MA retention, which was significantly enhanced compared to about 49.4% MA retention of octahedral PtNi (FIG. 4g, FIG. 8, Table 3). The morphological change of nanocatalysts after ADT was investigated by TEM. Significant aggregation was observed in commercial Pt/C (FIG. 9), attributing the low MA retention to the loss of the ECSA due to aggregation. For octahedral PtNi and PtNiCu, the activity loss can be explained by loss of the octahedral morphology to some extent and the leaching of (Ni and Cu) (FIG. 9, Table 4). Interestingly, significant composition change was observed for octahedral PtNi and PtNiCu after CV activation and ADT based on energy dispersive spectroscopy (EDS) analysis. After CV activation, the atomic Ni ratio in octahedral PtNi decreased from about 34.5% to about 15.2% (FIG. 4h, Table 4). In octahedral PtNiCu, Ni was reduced from about 16.8% to about 12.7%, Cu was reduced from about 16.9% to about 14.6%, and the total (Ni+Cu) was reduced from about 33.7% to about 27.3% (FIG. 4i, Table 4). It is found that relatively more Cu was retained within the octahedral PtNiCu compared to Ni, consistent with that Cu is more inert than Ni-based on their redox potentials. The overall fraction of Cu and Ni after activation for PtNiCu is about 27.3%, which was significantly higher than about 15.2% for PtNi. As the electrochemical cycling continues, after ADT (30000 CV cycles), octahedral PtNiCu still maintained about 11.9% Cu and about 5.5% Ni (total of about 17.4% Cu and Ni) while octahedral PtNi maintained about 6.3% Ni.

These experimental observations indicate that Ni dissolution can be significantly reduced by the presence of Cu. It was also evident that with the presence of Cu, the electrochemical performance of octahedral PtNiCu/C was significantly improved compared with octahedral PtNi/C.

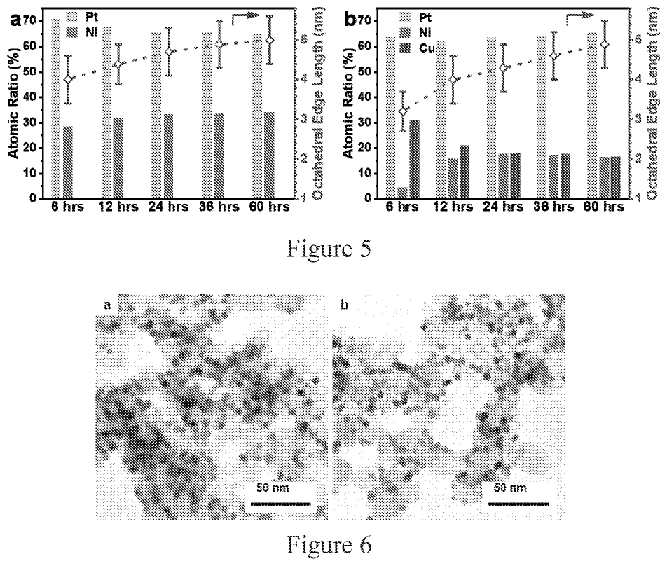

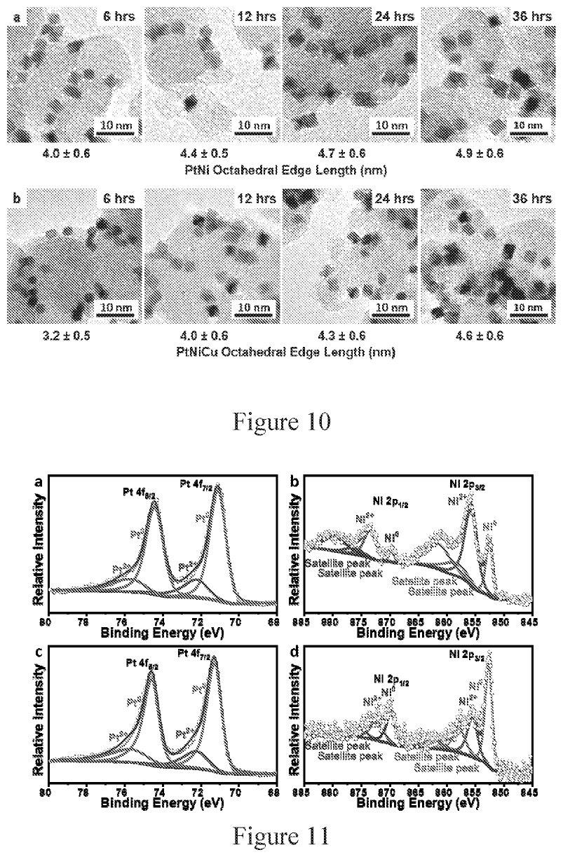

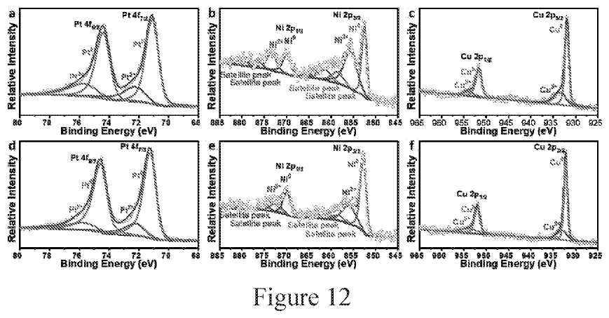

With the aid of EDS as well as TEM, time tracking experiments unveiled the composition evolution accompanied by octahedral size growth. For PtNi nanoparticles, the ratio of Ni continuously increased from about 28.7% to about 34.5% (all composition ratios are atomic ratios if without specific note), while the ratio of Pt decreased from about 71.3% to about 65.5% from six hours to 60 hours (FIG. 5a). In contrast to PtNi, PtNiCu nanoparticles comprised of about 64.1% Pt, about 31.2% Cu and about 4.7% Ni, after six hours of reaction. At 12 hours, the Cu ratio decreased to about 21.4% while the Ni ratio increased to about 16.1%. After 24 hours, Cu and Ni ratios were nearly equal (FIG. 5b). The time tracking of the composition indicated that Cu played a key role at an early stage of the nanoparticle nucleation and growth. The reduction rate of Cu was much faster than Ni during the reaction, resulting in a much higher atomic ratio of Cu (about 31.2%) than that of Ni (about 4.7%) at 6 hours. Both octahedral PtNi (4.0±0.6 to 5.0±0.6 nm) and PtNiCu (3.2±0.5 to 4.9±0.6 nm) showed continuous nanoparticle size growth from 6-60 hours (FIG. 5a, b), with the difference that PtNiCu nanoparticle showed a smaller size at early growth stage compared to PtNi (FIG. 10) possibly due to faster nucleation rates in the presence of Cu. Moreover, for PtNi, the time tracking showed that the overall Ni atomic ratio continued to increase during the growth process; while in PtNiCu the overall (Ni+Cu) ratio slightly decreased from 12 hours to 60 hours. This observation indicates that PtNi nanoparticles may show a higher (Ni+Cu) ratio on the surface than PtNiCu, given that both have similar overall (Ni+Cu) ratios at 60 hours. This is consistent with the X-ray photoelectron spectroscopy (XPS) characterization, which shows (Ni+Cu) are enriched on the surface of particles, with PtNi nanoparticles containing more (Ni+Cu) (Ni, about 45.1%) on the surface compared to PtNiCu ((Ni+Cu), about 39.7%) (Table 5, FIGS. 11, 12). To account for this large difference of the surface elemental distributions at different reaction times during the synthesis, the layer-by-layer composition profiles are calculated from the core to the surface of particles following the timeline of the growth process (FIG. 5a, b) (Details are provided in experimental details and methods).

### CONCLUSION

This example reports that octahedral PtNiCu nanoparticles synthesized with solution phase method showed significantly enhanced stability and activity compared to octahedral PtNi. It was found the introduction of the Cu precursor affected the growth kinetics of the nanoparticles, wherein a Cu-rich Pt alloy formed first, followed by the deposition of more Pt and Ni. Such PtNiCu nanoparticles were found to retain more Cu and Ni during electrochemical cycling compared to PtNi, leading to improved activity and stability.

Experimental Details and Methods:

Synthesis of Octahedral PtNiCu/C.

Octahedral PtNiCu/C was synthesized by utilizing about 8-10 mg platinum(II) acetylacetonate [Pt(acac)₂], about 4-6 mg nickel(II) acetate tetrahydrate [Ni(Ac)₂.4H₂O], and about 1-1.6 mg copper(II) acetate monohydrate [Cu(Ac)₂.H₂O] as metal precursors in an about 20-40 mL vial. About 60-70 mg benzoic acid was used for morphology control and about 9-11 mL N,N-dimethylformamide (DMF) was used for solvent and a reducing agent. The vial was then heated in an about 130-140° C. oil bath and slowly heated to about 150-160° C. for 10-15 hrs. The two-stage synthesis was designed for controlling octahedral size. In the second stage, about 1-2 mg Pt(acac)₂, about 0.5-1 mg Ni(Ac)₂.4H₂O, and about 0.5-1 mg Cu(Ac)₂.H₂O were dissolved in about 0.5-1 mL DMF and added into the vial after about 12 hrs reaction. Then the reaction temperature increased to about 160-170° C. and was kept at the temperature for about 40-60 hrs. After the reaction finished, the catalysts were collected by centrifugation, then dispersed and washed with isopropanol and acetone mixture.

Synthesis of Octahedral PtNi/C.

About 18-22 mg Vulcan XC-72 carbon black was dispersed in about 8-10 mL DMF under ultrasonication for about 30 mins in an about 20-40 ml vial. Then about 8-10 mg Pt(acac)₂, about 6-8 mg nickel(II) acetylacetonate [Ni(acac)₂], and about 80-95 mg benzoic acid were dissolved in about 0.5-1 ml DMF and were also added into the about 25 ml vial with carbon black dispersion. After ultrasonication for about 5 mins, the vial with the well-mixed solution was directly put into about 130-140° C. oil bath and then slowly heated to about 140-155° C. The vial was kept at about 140-155° C. for about 10-15 hrs. Then, about 1-2 mg Pt(acac)₂ and about 0.5-1 mg Ni(acac)₂ were dissolved in about 0.5-1 mL DMF and was added into the vial. Then the vial was kept in about 140-155° C. oil bath for another about 48 hrs. After the reaction finished, the catalysts were collected by centrifugation, then dispersed and washed with isopropanol and acetone mixture. Then the catalysts were dried in vacuum at room temperature and ready for characterization and electrochemistry test.

Electrode Preparation and Electrochemistry Test.

A typical catalyst ink was prepared by mixing about 2.5-3 mg of catalyst powder (octahedral PtNiCu/C or PtNi/C) with about 2 mL of an ethanol solution containing about 20 μL of Nafion (about 5 wt. %) with about 5 min ultrasonication time. Then, about 5-10 μL of catalyst ink was dropped onto an about 5 mm diameter glassy-carbon electrode (Pine Research Instrumentation). Estimation of Pt loading is based on overall Pt ratio within catalyst determined by ICP-AES. The ink was dried under an infrared lamp, and then the electrode was ready for the electrochemical test. Commercial Pt/C catalyst was used as the baseline catalysts, and similar procedure as described above was used to conduct the electrochemical measurement.

A three-electrode cell was used to carry out the electrochemical measurements. A working electrode was a catalyst coated glassy carbon electrode. An Ag/AgCl electrode was used as a reference electrode. Pt wire was used as a counter electrode. Cyclic Voltammetry (CV) measurements were conducted in an N₂ saturated about 0.1 M HClO₄ solution between about 0.05 to about 1.1 V vs. reversible hydrogen electrode (RHE) at a sweep rate of about 100 mV/s. Oxygen reduction reaction (ORR) measurements were conducted in an O₂ saturated about 0.1 M HClO₄ solution between about 0.05 to about 1.1 V vs. RHE at a sweep rate of about 20 mV/s. Accelerated degradation test (ADT) was performed in oxygen saturated about 0.1 M HClO₄ solution by applying cyclic potential sweeps between about 0.6 to about 1.0 V vs. RHE at a sweep rate of about 100 mV/s. For the CO stripping voltammetry measurements, working electrodes coated with different catalysts were firstly immersed in a CO-saturated about 0.1 M HClO₄ solution for about 15 min, and then the CO stripping voltammetry was recorded respectively between about 0.05 to about 1.1 V vs. RHE at a sweep rate of about 25 mV/s.

TABLE 1
Integrated charge ratio based on CO stripping results and hydrogen
underpotential deposition (H_{upd}). Electrochemical active
surface area (ECSA) based on CO stripping is calculated
by integration of CO striping peak with a conversion
constant of about 420 μC/cm². ECSA based on H_{upd} is calculated
by integration from about 0.05 to about 0.35 V vs.
RHE with a conversion constant of about 210 μC/cm². Q_{CO}/2Q_{H}
represents the electrochemical surface area difference
estimated by CO stripping and H_{upd} (Q represents the integrated charge).

| Sample | Q_{CO}/2Q_{H} |
|---|---|
| Pt/C | 1.01 |
| Octahedral PtNi/C | 1.14 |
| Octahedral PtNiCu/C | 1.08 |

TABLE 2
Performance comparison of the tested catalysts in this example.

| | Specific Activity | | |
|---|---|---|---|
| | (mA/cm²) | | Mass |
| | Based on | Based on CO | Activity |
| | H_{upd} | Stripping | (mA/μg_{Pt}) |
| This Example, | 0.39 ± 0.05 | 0.39 ± 0.05 | 0.28 ± 0.03 |
| Pt/C | | | |
| This Example, | 5.2 ± 0.3 | 4.6 ± 0.3 | 2.6 ± 0.2 |
| Octahedral PtNi/C | | | |
| This Example, | 6.2 ± 0.4 | 5.7 ± 0.4 | 3.7 ± 0.2 |
| Octahedral PtNiCu/C | | | |

TABLE 3
Activity retention of Pt/C, octahedral PtNi/C, PtNiCu/C
nanocatalysts after ADT (15000, 30000 CV cycles).

| | Specific Activity | |
|---|---|---|
| | (mA/cm²) | Mass Activity |
| After ADT cycles | based on H_{upd} | (mA/μg_{Pt}) |
| Pt/C (15k) | 89.2% | 69.1% |
| Pt/C (30k) | 88.2% | 64.8% |
| PtNi/C (15k) | 52.3% | 59.8% |
| PtNi/C (30k) | 48.3% | 49.4% |
| PtNiCu/C (15k) | 73.2% | 81.6% |
| PtNiCu/C (30k) | 62.4% | 69.3% |

TABLE 4
EDS composition comparison of octahedral PtNiCu,
PtNi nanostructures at initial stage, after
CV activation, after ADT (30000 CV cycles).

| Sample | Pt | Ni | Cu | (Ni + Cu) |
|---|---|---|---|---|
| Initial PtNiCu/C | 66.3% | 16.8% | 16.9% | 33.7% |
| Initial PtNi/C | 65.5% | 34.5% | / | 34.5% |
| PtNiCu/C After activation | 72.7% | 12.7% | 14.6% | 27.3% |
| PtNi/C After activation | 84.8% | 15.2% | / | 15.2% |
| PtNiCu/C After ADT | 82.6% | 5.5% | 11.9% | 17.4% |
| PtNi/C After ADT | 93.7% | 6.3% | / | 6.3% |

TABLE 5
Relative Pt, Ni, and Cu ratio of octahedral PtNi/C and octahedral
PtNiCu/C samples before and after activation (based on
XPS Ni 2p, Cu 2p, and Pt 4f peak integration).

| | | Relative Atomic Ratio (%) | | | |
|---|---|---|---|---|---|
| Sample | | Pt | Ni | Cu | Ni + Cu |
| Octahedral | before | 54.9 | 45.1 | / | 45.1 |
| PtNi/C | activation | | | | |
| | after activation | 90.1 | 9.9 | / | 9.9 |
| Octahedral | before | 60.3 | 21.1 | 18.6 | 39.7 |
| PtNiCu/C | activation | | | | |
| | after activation | 78.9 | 11.2 | 9.9 | 21.1 |

As used herein, the singular terms “a,” “an,” and “the” may include plural referents unless the context clearly dictates otherwise. Thus, for example, reference to an object may include multiple objects unless the context clearly dictates otherwise.

As used herein, the term “set” refers to a collection of one or more objects. Thus, for example, a set of objects can include a single object or multiple objects. Objects of a set also can be referred to as members of the set. Objects of a set can be the same or different. In some instances, objects of a set can share one or more common characteristics.

As used herein, the terms “connect,” “connected,” and “connection” refer to an operational coupling or linking. Connected objects can be directly coupled to one another or can be indirectly coupled to one another, such as via one or more other objects.

As used herein, the terms “substantially” and “about” are used to describe and account for small variations. When used in conjunction with an event or circumstance, the terms can refer to instances in which the event or circumstance occurs precisely as well as instances in which the event or circumstance occurs to a close approximation. For example, when used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, a first numerical value can be “substantially” or “about” the same as a second numerical value if the first numerical value is within a range of variation of less than or equal to ±10% of the second numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

As used herein, the term “size” refers to a characteristic dimension of an object. Thus, for example, a size of an object that is spherical can refer to a diameter of the object. In the case of an object that is non-spherical, a size of the non-spherical object can refer to a diameter of a corresponding spherical object, where the corresponding spherical object exhibits or has a particular set of derivable or measurable properties that are substantially the same as those of the non-spherical object. When referring to a set of objects as having a particular size, it is contemplated that the objects can have a distribution of sizes around the particular size. Thus, as used herein, a size of a set of objects can refer to a typical size of a distribution of sizes, such as an average size, a median size, or a peak size.

Additionally, concentrations, amounts, ratios, and other numerical values are sometimes presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a range of about 1 to about 200 should be understood to include the explicitly recited limits of about 1 and about 200, but also to include individual values such as about 2, about 3, and about 4, and sub-ranges such as about 10 to about 50, about 20 to about 100, and so forth.

While the disclosure has been described with reference to the specific embodiments thereof, it should be understood by those skilled in the art that various changes may be made and equivalents may be substituted without departing from the true spirit and scope of the disclosure as defined by the appended claims. In addition, many modifications may be made to adapt a particular situation, material, composition of matter, method, operation or operations, to the objective, spirit and scope of the disclosure. All such modifications are intended to be within the scope of the claims appended hereto. In particular, while certain methods may have been described with reference to particular operations performed in a particular order, it will be understood that these operations may be combined, sub-divided, or re-ordered to form an equivalent method without departing from the teachings of the disclosure. Accordingly, unless specifically indicated herein, the order and grouping of the operations are not a limitation of the disclosure.

1. An electrode material comprising:
a catalyst support; and
PtNiN-M nanostructures affixed to the catalyst support,
wherein N is a transition metal selected from Group 9 and Group 11 of the Periodic Table, and M is a transition metal selected from Group 5 and Group 6 of the Periodic Table.

2. The electrode material of claim 1, wherein N is Ag or Co.

3. The electrode material of claim 2, wherein M is Mo, W, Nb, or Ta.

4. The electrode material of claim 1, wherein the PtNiN-M nanostructures have a chemical composition represented by a formula: PtₐNi_{b}N_{c}-M_{d} wherein a>b, a>c, a>d, b>d, c>d, and a+b+c+d=100%.

5. An electrode material comprising:
a catalyst support; and
PtNi-based nanostructures affixed to the catalyst support, wherein at least one of the PtNi-based nanostructures includes an exterior shell of Pt.

6. The electrode material of claim 5, wherein the PtNi-based nanostructures include Pt, Ni, and at least one transition metal different from Pt and Ni.

7. An electrode material comprising:
a catalyst support; and
PtNi-based nanostructures affixed to the catalyst support, wherein at least one of the PtNi-based nanostructures includes an exterior shell and a core surrounded by the exterior shell, and a molar content of Pt in the exterior shell is greater than a molar content of Pt in the core.

8. The electrode material of claim 7, wherein the PtNi-based nanostructures include Pt, Ni, and at least one transition metal different from Pt and Ni.

9. The electrode material of claim 8, wherein the transition metal is Cu.

10. A fuel cell comprising:
an anode;
a cathode; and
an electrolyte disposed between the anode and the cathode,
wherein the cathode includes the electrode material of claim 1.

11. A metal-air battery comprising:
an anode;
a cathode; and
an electrolyte disposed between the anode and the cathode,
wherein the cathode includes the electrode material of claim 1.

12. A manufacturing method comprising:
providing PtN nanostructures in a liquid medium, wherein N is a transition metal selected from Group 9 and Group 11 of the Periodic Table; and
reacting a M-containing precursor, a Pt-containing precursor, and a Ni-containing precursor in the liquid medium to form PtNiN-M nanostructures, wherein M is a transition metal selected from Group 5 and Group 6 of the Periodic Table.

13. The manufacturing method of claim 12, wherein N is Cu, Ag, or Co, and M is Mo, W, Nb, or Ta.

14. The manufacturing method of claim 13, wherein providing the PtN nanostructures includes providing the PtN nanostructures affixed to a catalyst support.

15. The manufacturing method of claim 12, further comprising exposing the PtNiN-M nanostructures to an acid.

16. The manufacturing method of claim 12, further comprising annealing the PtNiN-M nanostructures in a reducing environment.

17. A manufacturing method comprising:
providing an electrode material including PtNi-based nanostructures affixed to a catalyst support; and
exposing the electrode material to an acid.

18. The manufacturing method of claim 17, further comprising annealing the electrode material in a reducing environment.

19. A manufacturing method comprising:
providing PtNiN nanostructures in a liquid medium, wherein N is a transition metal selected from Group 9 and Group 11 of the Periodic Table; and
reacting a Pt-containing precursor, a Ni-containing precursor, and a N-containing precursor with the PtNiN nanostructures in the liquid medium.

20. The manufacturing method of claim 19, wherein N is Cu.
